(19) United States
(12) Patent Application Publication
(10) Pub. No.: US 2014/0239766 A1
(43) Pub. Date: Aug. 28, 2014

(54) GENERATOR LEAD SYSTEM

(71) Applicant: GENERAL ELECTRIC COMPANY, Schenectady, NY (US)

(72) Inventors: Paul August Quail, Ballston Lake, NY (US); Blake Weldon Wilson, Glenville, NY (US); Cynthia V. Nous, Clifton Park, NY (US)

(73) Assignee: GENERAL ELECTRIC COMPANY, Schenectady, NY (US)

(21) Appl. No.: 13/781,748

(22) Filed: Feb. 28, 2013

(51) Int. Cl. H01R 39/34

(52) U.S. Cl. CPC H01R 39/34
USPC 310/232

(57) ABSTRACT

A system includes a generator. The generator is equipped with a plurality of field coils. A first collector ring is configured to be coupled to an excitation source. A first main lead is configured to direct a current through the plurality of field coils. The first main lead has first and second ends. The first end includes a first gooseneck axially coupled to the plurality of field coils. The second end is configured to axially couple to a first radial terminal of the generator.

### BACKGROUND OF THE INVENTION

The subject matter disclosed herein relates to power generation systems, and more specifically, to systems for improving the operability of the power generation systems.

Generators employ a combination of a rotor and a stator to convert rotational energy into electrical energy. For example, a current-carrying coil (e.g., field coil) creates a magnetic field, and rotation of the rotor within the magnetic field produces the electrical energy. During operation of the generator, the field coils may be subjected to thermal growth and/or centrifugal forces. Unfortunately, these thermal and mechanical stresses may decrease the operability of the field coils and the generator.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a generator. The generator is equipped with a plurality of field coils. A first collector ring may be coupled to an excitation source. A first main lead may direct a current from the first collector ring to the plurality of field coils. The first main lead includes first and second ends. The first end has a gooseneck radially coupled to the plurality of field coils. The second end may axially couple to a first radial terminal of the generator.

In a second embodiment, a power train system includes a shaft and a prime mover that may rotate the shaft. A generator is coupled to the shaft. The generator is equipped with a plurality of field coils, a radial terminal, and at least one main lead. The at least one main lead may direct a current through the plurality of field coils. In addition, the at least one main lead includes a gooseneck radially coupled to the plurality of field coils and an axial end coupled to the radial terminal.

In a third embodiment, a method includes a main lead assembly for a generator. A main lead may direct a current through a plurality of field coils. The main lead includes a gooseneck that may radially couple to the plurality of field coils and a first axial end that may couple to a radial terminal of the generator.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic drawing of an embodiment of a gas turbine system, illustrating a gas turbine and a steam turbine that may drive one or more generators;

FIG. 2 is a cross-sectional view of an embodiment of a rotor within the generators of FIG. 1, illustrating a main lead with features to direct a current through a plurality of field coils;

FIG. 3 is a partial cross-sectional view of an embodiment of the main lead of FIG. 2, illustrating a gooseneck shape to improve the operability of the main lead;

FIG. 4 is a partial cross-sectional view of an embodiment of the main lead of FIG. 3, taken along line 4-4, illustrating one or more channels within the main lead to route a cooling fluid along a length of the main lead; and

FIG. 5 is a partial cross-sectional view of an embodiment of the main lead of FIG. 3, taken along line 4-4, illustrating one or more channels within insulation surrounding the main lead to route a cooling fluid along a length of the main lead.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed towards systems for improving the operability of power generation systems. In certain embodiments, a generator includes a shaft rotating within a magnetic field to produce electrical power. The magnetic field may be induced by a current-carrying coil (e.g., field coil), which, in turn, may be energized by an excitation source. The excitation source and the field coils may be axially offset from one another, and thus, a main lead may be positioned to connect the excitation source to the field coils. During operation (e.g., start-up or steady-state operation) of the generator, the main lead may be subject to thermal expansion and centrifugal forces. In order to account for (e.g., counteract) these thermal and mechanical stresses, the main lead may incorporate a gooseneck design. That is, the main lead has at least one u-shaped bend that increases the flexibility of the main lead.

Furthermore, the main lead may be axially coupled to a radial terminal of the generator. The length of the main lead may axially offset the radial terminal from the field coils. As a result, the radial terminal may be removed and serviced without removing the field coils, which reduces the difficulty of maintaining or servicing the generator. In addition, such a configuration reduces mechanical stresses on the field coils and the main lead during operation of the generator.

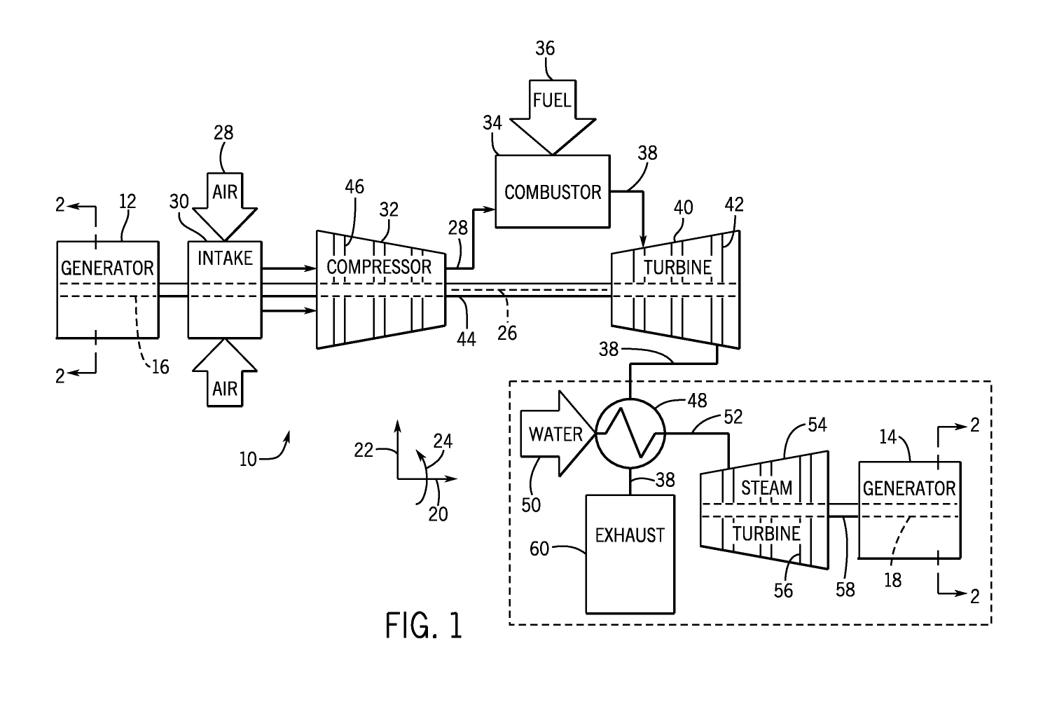

Turning now to the figures, FIG. 1 illustrates an embodiment of a gas turbine system 10 (e.g., a power train system) equipped with generators 12 and 14 to produce electrical power. More specifically, the generators 12 and 14 are equipped with respective rotors 16 and 18. When the rotors 16 and 18 rotate within a magnetic field, electrical power is produced by the generators 12 and 14. As noted above, the rotors 16 and 18 may include a gooseneck lead connection, an axial lead connection to a current-carrying terminal, or both, in order to improve the operability of the generators 12 and 14. It should be noted that certain embodiments of the gas turbine system 10 may include varying numbers of generators. For example, an embodiment of the gas turbine system 10 may include a single generator (e.g., may not include the generator 14). More generally, the gas turbine system 10 may include 1, 2, 3, 4, or more generators to produce electrical power. Additionally, the disclosed embodiments may be used with generators that are a part of other systems. In other words, the embodiments described below may be included with generators that are driven by other prime movers (e.g., a motor) or without a prime mover.

Throughout the discussion, a set of axes will be referenced. These axes are based on a cylindrical coordinate system and point in an axial direction 20, a radial direction 22, and a circumferential direction 24 that extends around the longitudinal axis 20. For example, the axial direction 20 extends along a longitudinal axis 26 of the gas turbine system 10, the radial direction 22 extends transversely away (e.g., perpendicularly) from the longitudinal axis 26, and the circumferential direction 24 extends around the longitudinal axis 26. Operation of the gas turbine system 10 is described below.

An oxidant 28 flows into intake 30, which subsequently directs the oxidant 28 to a compressor 32. The oxidant may include ambient air, pure oxygen, oxygen-enriched air, oxygen-reduced air, oxygen-nitrogen mixtures, or any suitable oxidant that facilitates combustion of fuel. In the following discussion, the oxidant 28 is described as air as one non-limiting example. The compressor 32 compresses the air 28 for delivery into a combustor 34. Within the combustor 34, a mixture of the air 28 and fuel (e.g., pressurized fuel) 36 is combusted into hot combustion gases 38. These combustion gases 38 flow into a turbine 40, which extracts work from the hot combustion gases 38. More specifically, the hot combustion gases 38 force turbine blades 42 into rotation, thereby driving a shaft 44 into rotation. The rotating shaft 44 also provides the energy for the compressor 32 to compress the air 28. That is, the shaft 44 rotates compressor blades 46 attached to the shaft 44 within the compressor 32, thereby pressurizing the air 28. In addition, the rotating shaft 44 (e.g., prime mover) may rotate the rotor 16 of the generator 12 (e.g., gas turbine generator), thereby producing electrical power.

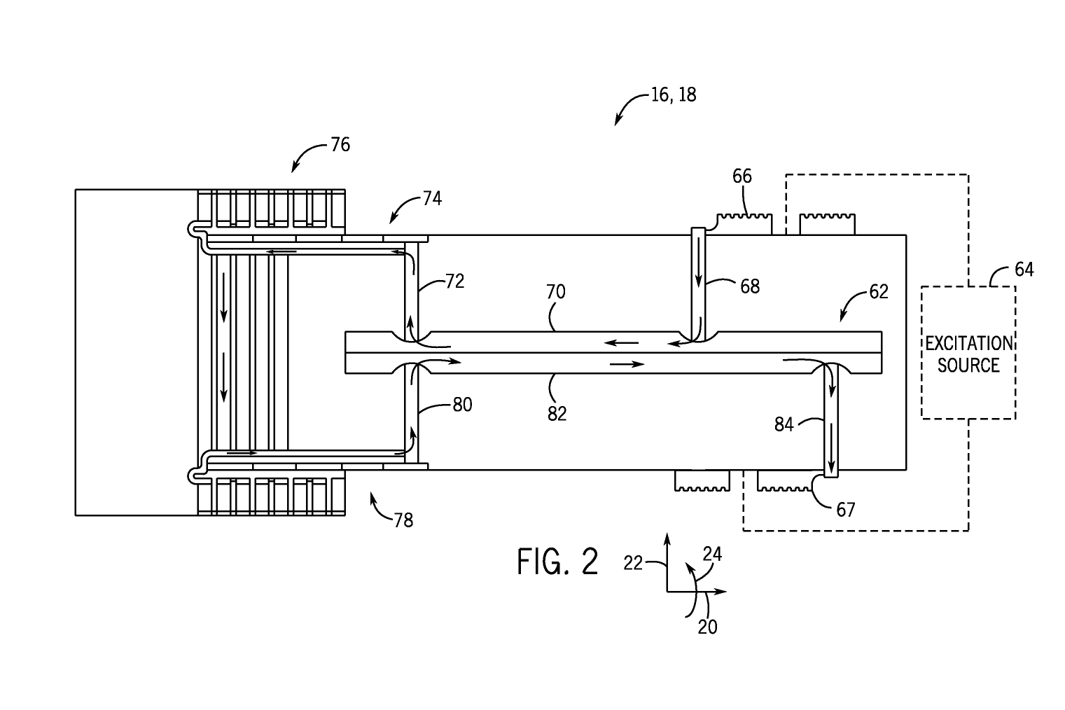

In the illustrated embodiment, the low pressure combustion gases 38 exit the turbine 40 and flow into a heat exchanger 48. Within the heat exchanger 48, heat from the combustion gases 38 is used to heat (e.g., boil) water 50 into steam 52. The steam 52 flows into a steam turbine 54, which extracts work from the steam 52. That is, the steam 52 forces turbine blades 56 to rotate, thereby driving a shaft 58 into rotation. The rotating shaft 58 (e.g., prime mover) may drive the generator 14 (e.g., steam turbine generator) to produce electrical power. Thereafter, the cooled, low pressure combustion gases 38 are discharged to an exhaust 60. In summary, the gas turbine generator 12 produces electrical power from the mechanical energy (e.g., pressure and velocity) of the combustion products 38, while the steam turbine generator 14 generates electrical power from the heat energy of the combustion products 38 (e.g., via the steam 52). Both of the generators 12 and 14 may benefit from the techniques disclosed herein, as discussed in detail with respect to FIGS. 2-6.

FIG. 2 is a cross-sectional view of an embodiment of a generator rotor. Specifically, the illustrated generator rotor may be the rotor 16 of the generator 12 or the rotor 18 of generator 14 illustrated in FIG. 1. However, as mentioned above, the generator rotor may also be of a generator that is powered by a prime mover other than the gas turbine engine 10. Further, in other embodiments, the generator may be a generator that is not be powered by a prime mover, such as a synchronous condenser.

As discussed in detail below, the disclosed embodiments may include a gooseneck design to improve the flexibility of the rotors 16 and 18 during operation of the generators 12 and 14. In particular, the rotors 16 and 18 include a current-carrying system 62. As noted above, rotation of the rotors 16 and 18 within a magnetic field may produce electrical energy. When energized, the current-carrying system 62 produces the magnetic field within the respective generators 12 and 14, thereby enabling the production of electrical energy.

The current-carrying system 62 may be energized by an excitation source 64. The excitation source 64 may be, for example, a connection to a power grid. The current-carrying system 62 includes collector rings 66 and 67 that may be coupled to the excitation source 64. That is, when the excitation source 64 is coupled to the collector rings 66 and 67, a complete electrical circuit is formed, thereby enabling current flow from the excitation source 64 through the current-carrying system 62. As discussed below, the current-carrying system 62 includes various features to enable efficient and operable flow of this current.

From the collector ring 66, the current may flow radially 22 through a first radial stud 68, axially 20 along a first axial conductor 70, radially 22 through a first radial terminal 72, and substantially axially 20 through a first main lead assembly 74 toward a plurality of field coils 76. As will be appreciated, when the field coils 76 are excited by the current, the field coils 76 produce the magnetic field for the generator. In order to complete the electrical circuit, the current may flow from the field coils 76 through a second main lead assembly 78 in a substantially axial direction 20, radially 22 through a second radial terminal 80, axially 20 along a second axial conductor 82, and radially 22 through a second radial stud 84 back to the collector ring 67. Thus, in certain embodiments, the current may flow along a path generally illustrated by the arrows. It should be noted that the illustrated configuration of the current-carrying system 62 is given by way of example, and is not intended to be limiting. That is, generator rotors 16 and 18 may employ a variety of geometries and designs, and alternative designs would still fall within the spirit and scope of this disclosure. For example, although the current-carrying system 62 is illustrated with two main lead assemblies (e.g., 74 and 78), certain embodiments may include any other number (e.g., 1, 2, 3, 4, or more) main lead assemblies.

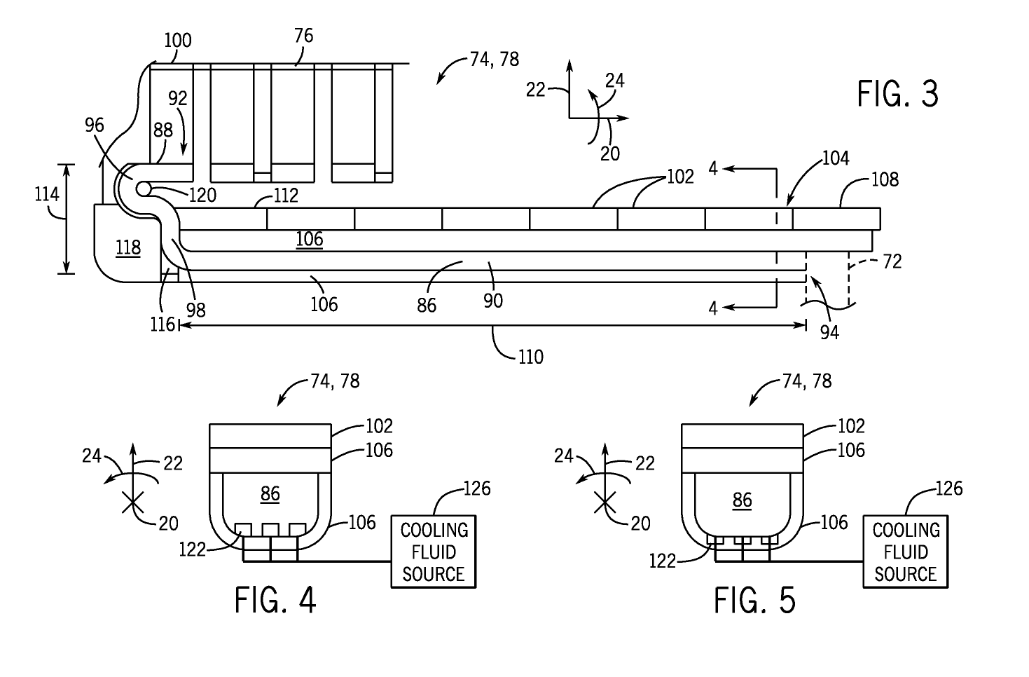

FIG. 3 illustrates a partial cross-sectional view of the main lead assemblies 74 and 78. Again, the main lead assemblies 74 and 78 may include a gooseneck design as well as an axial coupling to the radial studs 68 and 84 to improve the flexibility of the rotors 16 and 18 during operation of the generators 12 and 14. For clarity, the following discussion is directed toward the main lead assembly 74. However, it should be appreciated that the disclosed techniques may also be applied to the main lead assembly 78, as well as any other main lead assemblies of the rotor 16.

The main lead assembly 74 includes a main lead 86 extending from the radial stud 72 to the field coils 76. In certain embodiments, the main lead 86 may be constructed from copper leaf (e.g., thin copper sheets stacked, wound, or wrapped together), zinc, or another thin conductive material. Copper leaf may be particularly applicable in generators with a high amount of cycling (e.g., repeated generator startups), due to the flexibility provided by the copper leaf. The copper leaf enables the main lead 86 to compress and expand in response to mechanical and thermal stresses. The thickness of the copper leaf may be based on the anticipated mechanical and thermal stresses, which, in turn, may be based on a rated current or base load of the generator (e.g., number of consecutive operating hours). For example, if the generator 12 or 14 has a lower base load and higher amount of cycling, the main lead 86 may have a greater thickness.

As shown, the main lead 86 includes a gooseneck portion 88 and a substantially axial portion 90 that collectively extend between opposite axial ends 92 and 94 of the main lead 86. The gooseneck portion 88 may be subdivided into a generally u-shaped portion 96 and a rounded elbow portion 98. Although one u-shaped portion 96 is shown, the main lead 86 may include a plurality of u-shaped portions 96, such as 1 to 100 u-shaped portions 96. For example, 1, 2, 3, 4, 5, 6, 7, 8, 9, 10, or more u-shaped portions 96 may be included with the main lead 86. Each u-shaped portion 96 is configured to expand and contract in response to movement (e.g., thermal expansion or contraction) in the radial direction 22, or the axial direction 20, or the circumferential direction 24, or any combination thereof. For example, each u-shaped portion 96 may function as a spring, absorber, or resiliently compressible structure. For example, in operation, the u-shaped portion 96 of the gooseneck 88 enables thermal growth of the main lead 86 in the radial direction 22. For example, the elbow portion 98 may transfer radial stresses from the axial portion 90 to the u-shaped portion 96, thereby enabling thermal growth without displacing the axial portion 90 of the main lead 86. It should be noted, however, that certain embodiments of the main lead 86 may be designed without the elbow portion 98.

The axial portion 90 is axially 20 coupled (e.g., brazed or bolted) to the radial support stud 72. The gooseneck portion 88 is radially 22 coupled (e.g., brazed) to the plurality of field coils 76. In certain embodiments, the gooseneck portion 88 may be brazed to an innermost field coil 100 (e.g., axially 20 innermost from the radial terminal 72). The radial coupling reduces stresses on the gooseneck portion 88, which generally improves the operability of the main lead 86. In addition, the flexibility of the gooseneck portion 88 allows a greater tolerance on the position of the radial coupling. Accordingly, the ease of assembling the main lead assembly 74 may be improved.

Due to the axial coupling of the main lead 86 to the radial stud 72, the field coils 76 and the radial stud 72 are axially 20 offset from one another. As a result, the radial stud 72 may be removed and maintained without removing the field coils 76 or the main lead 86. To this end, the main lead assembly 74 includes a plurality of wedges 102 (e.g., annular wedges) disposed on an exterior surface 104 of the rotor 16 or 18. The wedges 102 may be removed in order to expose insulation 106 (e.g., glass insulation) beneath the wedges 102. Furthermore, the insulation 106 may be removed in order to expose the main lead 86 and the radial stud 72. As noted earlier, the main lead 86 may be constructed of copper leaf, which provides flexibility to the main lead 86. During maintenance of the main lead 86, the axial end 94 may be bent radially 22 in order to facilitate removal of the radial stud 72. In certain embodiments, it may be desirable to braze a portion of the copper leaf near the axial end 94 in order to strengthen the portion of the main lead 86 that is bent during maintenance. This braze may also reduce the possibility of twisting (e.g., circumferential 24 movement) or otherwise damaging the copper leaves during assembly of the generator 12.

In the configuration shown, an axially 20 innermost wedge 112 (e.g., relative to the radial stud 72) may be subjected to a higher amount of stress than the remaining wedges 102. That is, the gooseneck portion 88 of the main lead assembly 74 may enable a non-uniform stress profile within the wedges 102. In certain embodiments, the stresses experienced by the wedges 102 may increase (e.g., monotonically) from an axially innermost wedge 112 to the axially outermost wedge 108. Accordingly, the wedges 102 may be designed differently from one another, based on an anticipated stress profile. Indeed, the axially innermost wedge 112 may be designed to support a higher load than the axially outermost wedge 108. To this end, the axially innermost wedge 112 may have a greater thickness, length, density, volume, material, or any combination thereof, as compared to the remaining wedges 102.

The axial portion 90 of the main lead 86 defines the axial offset 110 of the main lead 86. In a similar manner, the gooseneck portion 88 of the main lead 86 defines a radial height 114 that is generally less than the axial offset 110 of the main lead 86. The axial offset 110 enables the axial conductor 70 of FIG. 2 to be shortened, thereby improving the stability of the axial conductor 70. In certain embodiments, the axial conductor 70 may be disposed within a channel (e.g., axial 20 channel) of the rotor 16, and the shortened length may render the axial conductor 70 less susceptible to movement within the channel. The axial offset 110 of the main lead 86 also reduces the possibility of twisting within the gooseneck portion 88. More specifically, the gooseneck portion 88 rests within a channel 116 (e.g., radial 22 channel) of the main lead assembly 74 and is axially 20 restrained or biased by support 118, innermost wedge 112 and insulation 106. This restraint may reduce twisting and movement of the gooseneck portion 88 during operation of the generator 12. A support pin 120 (e.g., circumferential 24 support pin) may also be employed to reduce twisting, as well as to support the weight of the gooseneck portion 88.

As noted earlier, the main lead 86 may be subjected to thermal stresses during operation of the generator 12. In order to reduce these stresses, the main lead assembly 74 may include one or more channels that route a cooling fluid (e.g., by forced convection), as illustrated by FIGS. 4 and 5. These channels may be coupled to a cooling fluid source 126 (e.g., internal generator cooling gas), which provides the cooling fluid to the main lead 86. For example, the cooling fluid source 126 may be a ventilation flow path of the generator 12 or 14, and the cooling fluid may be a gas flow within the ventilation flow path. The cooling fluid may be, for example, air, nitrogen, argon, another inert gas, or any combination thereof. In certain embodiments, the cooling fluid may flow through holes at different radii on the rotor 16 or 18 of the generator 12 or 14. For example, a cooling fluid flow may pass from a ventilation flow path of the generator 12 or 14, through holes in the rotor 16 or 18, and into conduits or channels 122 in the main lead 86.

FIG. 4 illustrates a plurality of conduits or channels 122 disposed within the main lead 86. For example, the channels 122 may be recessed or coupled to the lead 86. The channels 122 extend along the axial length 110 of the main lead 86. As shown, the channels 122 have an approximately square shape, but may have any other suitable shape. More specifically, the channels 122 may be square, rectangular, circular, polygonal, or otherwise arcuate. Furthermore, the number of channels 122 may vary in certain embodiments. That is, the main lead 86 may include 1, 2, 3, 4, or more channels 122 formed within the main lead 86. During operation of the generator 12, cooling fluid may be routed through the channels 122 in order to cool the main lead 86 to a desired temperature. In certain embodiments, the channels 122 may be disposed within the insulation 106 (e.g., recessed or coupled to the insulation 106) of the main lead assembly 74, as shown in FIG. 5. That is, the channels 122 enable the cooling fluid to contact the surface of the main lead 86, thereby cooling the main lead 86 during operation of the generator 12.

Technical effects of the invention include the main lead 86 for the generator (e.g., generator 12, 14) with features to improve the operability of the generator. More specifically, the main lead 86 includes the gooseneck portion 88 that enables thermal growth of the main lead 86. In addition, the main lead 86 is radially coupled to the field coils 76 and axially coupled to the radial stud 72. Due to the flexibility of the gooseneck portion 88, such a configuration enables a greater tolerance on the position of the radial coupling to the field coils 76. Furthermore, the radial terminal 72 may be removed and serviced without removing the field coils 76 which reduces the difficulty of maintaining the generator. This may be particularly desirable in designs where the generator is located between two prime movers.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a generator, comprising:
a plurality of field coils;
a first collector ring configured to be coupled to an excitation source;
a first main lead configured to direct a current from the first collector ring to the plurality of field coils, wherein the first main lead comprises:
a first end comprising a first gooseneck radially coupled to the plurality of field coils; and
a second end axially coupled to a first radial terminal of the generator.

2. The system of claim 1, wherein the first gooseneck is radially coupled to an axially innermost field coil of the plurality of field coils.

3. The system of claim 1, wherein the first main lead comprises an axial portion extending from the second end to the gooseneck, the axial portion defines an axial length, the gooseneck defines a radial length, and the axial length is greater than the radial length.

4. The system of claim 3, wherein the first main lead comprises at least one channel configured to receive and direct a coolant along the axial length of the first main lead.

5. The system of claim 1, comprising:
a first radial stud coupled to the first collector ring; and
a first axial conductor coupled to the first radial stud.

6. The system of claim 5, wherein the first gooseneck comprises at least one u-shaped portion, and the first gooseneck is restrained by a support block of the generator.

7. The system of claim 5, comprising:
a second collector ring configured to be coupled to the excitation source;
a second main lead configured to direct the current from the plurality of field coils to the second collector ring, wherein the second main lead comprises:
a third end having a second gooseneck radially coupled to the plurality of field coils; and
a fourth end axially coupled to a second radial terminal of the generator.

8. The system of claim 7, comprising:
a second radial stud coupled to the second collector ring; and
a second axial conductor coupled to the second radial stud.

9. The system of claim 1, wherein the first main lead comprises copper leaf, and wherein a portion of the copper leaf is brazed together.

10. A power train system, comprising:
a shaft;
a prime mover configured to rotate the shaft; and
a generator coupled to the shaft, wherein the generator comprises:
a plurality of field coils;
a radial terminal; and
at least one main lead configured to direct a current through the plurality of field coils, wherein the at least one main lead comprises a gooseneck having at least one u-shaped portion radially coupled to one of the plurality of field coils and an axial end axially coupled to the radial terminal.

11. The power train system of claim 10, wherein the at least one main lead comprises a channel configured to receive and direct a coolant along an axial length of the at least one main lead.

12. The power train system of claim 10, comprising insulation surrounding an axial portion of the at least one main lead.

13. The power train system of claim 12, wherein the insulation comprises a channel configured to receive and direct a coolant along an axial length of the axial portion.

14. The power train system of claim 12, comprising a plurality of wedges disposed radially between the plurality of field coils and the insulation, wherein the plurality of wedges are configured to be removable to expose the at least one main lead, the radial terminal, the insulation, or any combination thereof.

15. The power train system of claim 10, wherein the gooseneck is restrained by a support block of the generator.

16. The power train system of claim 10, wherein the prime mover comprises a gas turbine or a steam turbine.

17. A system, comprising:
a main lead assembly for a generator, comprising:
a main lead configured to direct a current through a plurality of field coils, wherein the main lead comprises a gooseneck configured to radially couple to one of the plurality of field coils and a first axial end configured to couple to a radial terminal of the generator.

18. The system of claim 17, wherein the main lead comprises at least one channel configured to receive and direct a coolant along an axial length of the main lead.

19. The system of claim 17, comprising:
a coolant source configured to direct a coolant to the at least one channel of the main lead.

20. The system of claim 19, wherein the coolant source comprises a ventilation path of the generator, and the coolant comprises a gas flow in the ventilation path.
